(19) United States
(12) Patent Application Publication
(10) Pub. No.: US 2026/0195918 A1
(43) Pub. Date: Jul. 9, 2026

(54) SYSTEMS AND METHODS FOR ADAPTIVE CONTENTION- AND CONTENT-AWARE THREE-DIMENSIONAL OBJECT DETECTION

(71) Applicants: Purdue Research Foundation, West Lafayette, IN (US); WISCONSIN ALUMNI RESEARCH FOUNDATION, Madison, WI (US)

(72) Inventors: Somali Chaterji, West Lafayette, IN (US); Saurabh Bagchi, West Lafayette, IN (US); PengCheng Wang, West Lafayette, IN (US); Shayok Bagchi, West Lafayette, IN (US); Yin Li, Madison, WI (US); Zhuoming Liu, Madison, WI (US)

(21) Appl. No.: 19/441,499

(22) Filed: Jan. 6, 2026

Related U.S. Application Data
(60) Provisional application No. 63/742,344, filed on Jan. 6, 2025.

(51) Int. Cl. G06T 7/70; G06T 3/40; G06T 7/11; G06T 15/08

(52) U.S. Cl. CPC G06T 7/70; G06T 3/40; G06T 7/11; G06T 15/08; G06T 2207/10028; G06T 2207/20084

(57) ABSTRACT

Systems, methods, and media implement object detection according to control knobs or modules including a partitioning module, a spatial resolution module, a spatial encoding module, a feature extraction module, and a detection module. The techniques include acquiring point cloud data obtained from a LiDAR sensor; determining a partitioning format for the point cloud data; partitioning the point cloud data in the determined partitioning format; adjusting a size of the partitioned point cloud data based on a granularity of spatial information; encoding the portioned point cloud data into voxels using a voxelization method; selecting a neural network model, wherein the neural network model is compatible with the partitioning format; inputting the encoded, partitioned point cloud data to the selected neural network model; and outputting object localization results for the point cloud data.

### CROSS-REFERENCE TO RELATED APPLICATIONS

This application claims priority to and the benefit of U.S. Provisional Application No. 63/742,344, filed Jan. 6, 2025, and titled “Agile3D: Adaptive Contention- and Content-Aware 3D Object Detection for Embedded GPUs,” the entire contents of which are herein incorporated by reference for all purposes.

### STATEMENT REGARDING FEDERALLY SPONSORED RESEARCH OR DEVELOPMENT

This invention was made with government support under 2333487 and 2146449 awarded by the National Science Foundation. The government has certain rights in the invention.

### TECHNICAL FIELD

This disclosure relates to the field of atom and molecule analyzers. More particularly, this disclosure relates to systems and methods for universal analyzers, for example using semiconductor/insulator heterostructures.

### BACKGROUND

Unlike 2D object detection models that leverage structured image data with stable latency of CNN-based models, 3D detection must contend with the irregularity and sparsity of point clouds, requiring specialized encoders for voxelization and sparse convolutions. These operations can increase computational demands, leading to latency variability. In practice, real-world deployments rarely achieve peak performance due to resource sharing among concurrent applications, exacerbating latency unpredictability and complicating latency constraints such as, for example, the 10-20 Hz acquisition rates of modern Light Detection and Ranging (LiDAR) systems. This gap highlights the need for adaptable 3D detection solutions targeted for resource and latency constraints, especially in cost- and energy-sensitive scenarios.

Extending these 2D techniques to 3D workloads presents several challenges. First, adjustments to parameters like voxel size require retraining of the model, due to the way such changes alter the input data representation. For example, variations in voxel size or spatial resolution affect how the point cloud is divided into grids (voxelization) and how spatial features are encoded. These shifts disrupt downstream computations, such as sparse convolutions, rendering pre-trained weights incompatible with the modified data structure. Consequently, the model often is retrained or extensively fine-tuned to restore performance, making single-model branching impractical for 3D systems. This limitation necessitates cross-model branching for 3D workloads, enabling dynamic adaptation to diverse input characteristics and resource constraints. Although cross model branching increases memory usage, a lower memory footprint of 3D models is used. Second, unlike 2D models that process pixels defined on regular grids with stable latency, 3D models handle irregular point clouds, and thus exhibit higher latency variability under resource contention. This key difference leads to significant variance in latency when executing the same branch (i.e., the same single model) across different input point clouds even without contention. Such variability necessitates scheduling techniques to dynamically select execution branches in response to changing input content and resource contention.

These complexities expose a gap: comparative frameworks lack the mechanisms to dynamically adapt 3D object detection to simultaneous variations in input content and resource contention. Bridging this gap demands the development of resource-aware systems capable of balancing accuracy and latency at runtime, while adhering to stringent service level objectives (SLOs) across diverse deployment environments.

3D object detection can be used in applications such as autonomous vehicles, delivery drones, robotics, and AR/VR systems to enable safe navigation and obstacle avoidance. LiDAR technology, which generates 3D point clouds, forms the foundation of these systems. However, processing high volume, irregular point cloud data on resource-constrained embedded hardware can be challenging according to comparative examples.

### SUMMARY

These and other problems may be overcome by systems, methods, and devices having configurations as set forth herein. Thus, the present disclosure provides for an adaptive, contention- and content-aware 3D object detection system.

According to one aspect of the present disclosure, an adaptive three-dimensional object detection system is provided. The system comprises a memory; a controller configured to control one or more of: a partitioning module, a spatial resolution module, a spatial encoding module, a feature extraction module, or a detection module stored in the memory; and a processor electrically coupled to the controller and programmed to: a processor electrically coupled to the controller and programmed to: acquire point cloud data obtained from a LiDAR sensor, determine, via the partitioning module, a partitioning format for the point cloud data, partition the point cloud data in the determined partitioning format, adjust, via the spatial resolution module, a size of the partitioned point cloud data based on a granularity of spatial information, encode, via the spatial encoding module, the portioned point cloud data into voxels using a voxelization method, select, via the feature extraction module, a neural network model, wherein the neural network model is compatible with the partitioning format, input the encoded, partitioned point cloud data to the selected neural network model, and output, via the selected neural network model, object localization results for the point cloud data.

According to another aspect of the present disclosure, a method for performing object detection in a three-dimensional environment is provided. The method comprises acquiring point cloud data obtained from a LiDAR sensor; determining, via a partitioning module, a partitioning format for the point cloud data; partitioning the point cloud data in the determined partitioning format; adjusting, via a spatial resolution module, a size of the partitioned point cloud data based on a granularity of spatial information; encoding, via a spatial encoding module, the portioned point cloud data into voxels using a voxelization method; selecting, via a feature extraction module, a neural network model, wherein the neural network model is compatible with the partitioning format; inputting the encoded, partitioned point cloud data to the selected neural network model; and outputting, via the selected neural network model, object localization results for the point cloud data.

According to another aspect of the present disclosure, a non-transitory computer readable medium is provided. The medium stores instructions that, when executed, cause a processor to acquire point cloud data obtained from a LiDAR sensor; determine, via a partitioning module, a partitioning format for the point cloud data; partition the point cloud data in the determined partitioning format; adjust, via a spatial resolution module, a size of the partitioned point cloud data based on a granularity of spatial information; encode, via a spatial encoding module, the portioned point cloud data into voxels using a voxelization method; select, via a feature extraction module, a neural network model, wherein the neural network model is compatible with the partitioning format; input the encoded, partitioned point cloud data to the selected neural network model; and output, via the selected neural network model, object localization results for the point cloud data.

### BRIEF DESCRIPTION OF THE DRAWINGS

FIG. 1 is a block diagram illustrating an example system for an adaptive three-dimensional object detection system, according to some examples.

FIG. 2 is a flowchart illustrating an example process for performing object localization, according to some examples.

FIG. 3 is a block diagram of an object localization system that integrates dynamic branch selected based on input content, contention levels, and latency SLOs, according to some examples.

FIG. 4 is a block diagram of a contention- and content-aware RL-based (CARL) controller that uses shared architecture for policy and reference models, according to some examples.

FIG. 5 is a graph of an example comparison of execution time and model size for two-dimensional and three-dimensional models.

FIG. 6 is a graph of an example comparison of mean latencies with standard deviations across branches.

FIG. 7 is a graph of an example comparison of three-dimensional models at different spatial resolutions.

FIG. 8A is an example visualization of diverse points clouds identifying vehicles.

FIG. 8B is an example visualization of diverse point clouds identifying pedestrians.

FIG. 8C is an example visualization of diverse points clouds identifying a mix of pedestrians, cyclists, and vehicles.

FIG. 9A is a graph of an example evaluation of an object localization system across varying contention levels at a latency SLO of 500 ms.

FIG. 9B is a graph of an example evaluation of an object localization system across varying contention levels at a latency SLO of 350 ms.

FIG. 9C is a graph of an example evaluation of an object localization system across varying contention levels at a latency SLO of 100 ms.

FIG. 10 is a graph of an example evaluation of an object localization system for changing contention levels on a Waymo test set.

FIG. 11 is a graph of an example evaluation of an object localization system versus various baselines for latency SLOs of 50-350 ms.

FIG. 12 is a graph of an example evaluation of an object localization system versus various baselines for latency SLOs of 100-250 ms.

FIG. 13 is a graph of an example evaluation of an object localization system versus various baselines for latency SLOs of 50-150 ms.

FIG. 14 is a graph of an example evaluation of an object localization system under three latency SLOs using Waymo.

FIG. 15A is a graph of an example evaluation of an object localization system switching overhead on Orin.

FIG. 15B is a graph of an example evaluation of an object 1 localization system switching overhead on Xavier.

FIG. 16 is a graph of an example accuracy evaluation of an object localization system's branches.

FIG. 17 is a graph of an example accuracy evaluation of an object localization system's voxel and pillar size.

FIG. 18 is a graph of an example accuracy evaluation of an object localization system's identification of vehicles, cyclists, and pedestrians.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts, and embodiments described herein may be implemented and practiced without these specific details.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration. Moreover, discussion of “horizontal” or “vertical” features may in some implementations be relative to the earth's surface; however, in other implementations a mass spectrometer may be installed in a different orientation such that a “horizontal” feature is not necessarily parallel to the earth's surface. Thus, more generally “horizontal” or “longitudinal” may refer to the extending direction of spectrometer core components (i.e., of a heterostructure), whereas “vertical” or “lateral” may refer to a direction perpendicular to longitudinal.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as, e.g., “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as, e.g., “either,” “one of,” “only one of,” or “exactly one of.”

Various objects, features, and advantages of the disclosed subject matter can be more fully appreciated with reference to the following detailed description of the disclosed subject matter when considered in connection with the following drawings, in which like reference numerals identify like elements. It should be understood that the drawings are not to scale unless otherwise indicated.

Described herein is an adaptive 3D system that employs a Multi-branch Execution Framework (MEF) that includes five control knobs: partitioning format, spatial resolution, spatial encoding method, 3D feature extractor variants, and detection heads. These control knobs enable over 50 unique model configurations, allowing the system to adapt its execution strategy based on input data, resource availability, and system SLOs. Notably, the first four of these five control knobs are specifically designed for 3D point cloud object detection, distinguishing these systems and methods from comparative 2D adaptive frameworks. While the MEF facilitates dynamic operation, the Contention- and Content-Aware RL-based (CARL) controller enables system adaptability through fine-grained scheduling. CARL dynamically selects preferred branches at runtime, addressing variability in input content, hardware constraints, and latency SLOs. Comparative RL-based controllers often depend on human-designed reward functions, which often lead to poor results. CARL overcomes this limitation by employing Direct Preference Optimization (DPO), a method that eliminates the need for manual reward tuning by learning directly from preference comparisons. CARL adapts this concept of human-labeled “good” and “bad” outputs for 3D detection by leveraging a heuristic beam search oracle to label preferred branches. This approach replaces the need for extensive manual labeling, ensuring efficient training and robust adaptability. As a result, CARL achieves improved accuracy and adaptability in complex 3D tasks, even under dynamic runtime conditions.

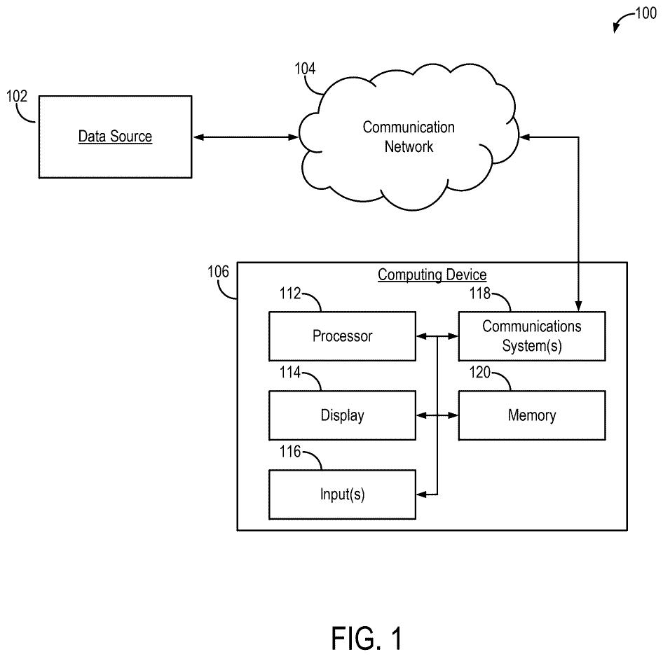

Certain techniques and advantages described herein can be achieved via a variety of different hardware configurations. For example, software instructions that operate on cloud point, LiDAR data, from a sensor could operate on a processor of the same device as the sensor, a locally connected device, or a remote resource. Thus, FIG. 1 provides general examples of possible configurations of hardware implementing aspects of the disclosure.

FIG. 1 shows a block diagram illustrating an example of a system 100 for an adaptive three-dimensional object detection system. In some examples, a computing device 106 can obtain cloud-point data from a data source 102 (such as a LiDAR sensor) or other connected device via a communication network 104. As will be understood from the description herein, the data source 102 may be a standalone sensor, or may be a variety of types of sensors.

In some examples, data source 102 can be local to computing device 106. For example, data source 102 can be incorporated with computing device 106 (e.g., computing device 106 can be configured as part of a device for measuring, recording, estimating, acquiring, or otherwise collecting or storing data). As another example, data source 102 can be connected to computing device 106 by a cable, a direct wireless link, and so on. Additionally or alternatively, in some examples, data source 102 can be located locally and/or remotely from computing device 106, and can communicate data to computing device 106 via a communication network (e.g., communication network 104).

The computing device 106 can include a processor 112. In some examples, the processor 112 can be any suitable hardware processor or combination of processors, such as a central processing unit (CPU), a graphics processing unit (GPU), a tensor processing unit (TPU), a neural processing unit (NPU), an extendable processing unit (XPU), an application specific integrated circuit (ASIC), a field-programmable gate array (FPGA), a digital signal processor (DSP), a microcontroller (MCU), cloud resource, etc.

The computing device 106 can further include, or be connected to, a memory 120. The memory 120 can include or comprise any suitable storage device(s) that can be used to store suitable data (e.g., cloud-point data, object detection modules, etc.) and instructions that can be used, for example, by the processor 112. The memory may be a memory that is “onboard” the same device as the sensor that detects the frames, may be a memory of a separate device connected to the computing device 106, or combinations thereof. Methods for detecting and identifying objects within data from the data source 102 may operate as its independent processes/modules, such as separate modules (or ‘knobs’) that run on the same processor 112 or a specialty processor (such as a GPU) that achieves greater efficiency in processing the frame data through projection operations, as described below. The memory 120 can include any suitable volatile memory, non-volatile memory, storage, or any suitable combination thereof. For example, memory 120 can include random access memory (RAM), read-only memory (ROM), electronically-erasable programmable read-only memory (EEPROM), one or more flash drives, one or more hard disks, one or more solid state drives, one or more optical drives, etc.

In further examples, computing device 106 can receive or transmit information and/or any other suitable system over a communication network 104. In some examples, the communication network 104 can be any suitable communication network or combination of communication networks. For example, the communication network 104 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In one example, communication network 104 can be a local area network, a wide area network, a public network (e.g., the Internet), a private or semi-private network (e.g., a corporate or university intranet), any other suitable type of network, or any suitable combination of networks. Communications links shown in FIG. 1 can each be any suitable communications link or combination of communications links, such as wired links, fiber optic links, Wi-Fi links, Bluetooth links, cellular links, etc.

In further examples, computing device 106 can further include a display 114 and/or one or more inputs 116. In one example, the display 114 can include any suitable display devices, such as a computer monitor, a touchscreen, a television, an infotainment screen, etc. to display the report. In further examples, and/or the input(s) 116 can include any suitable input devices (e.g., a keyboard, a mouse, a touchscreen, a microphone, etc.). In yet further examples, the data source 102 may be a sensor that exports LiDAR or cloud-point data to a remote computing device 106, then receives object detection results from the computing device 106 and displays them on a display 118 of the camera itself. In such an instance the display 114 and inputs 116 may be part of the sensor 102, or a device housing the sensor 102.

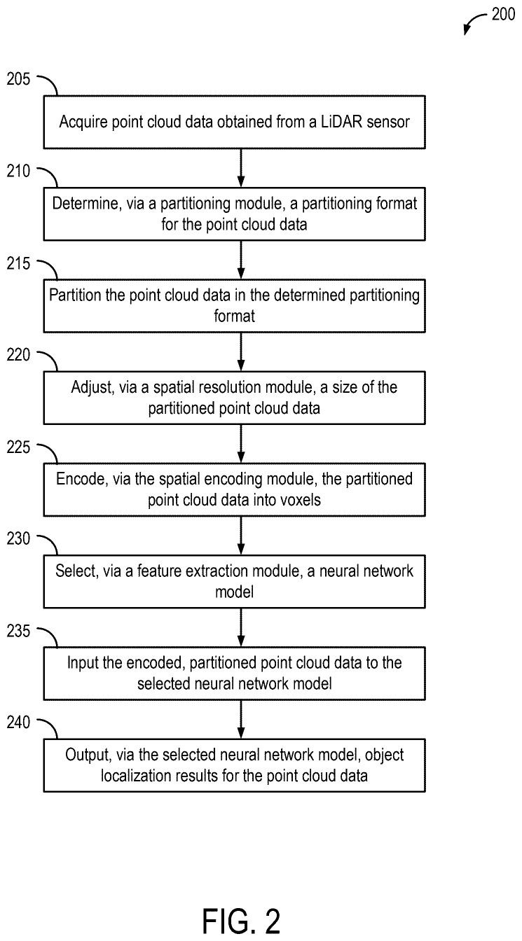

FIG. 2 is a flow diagram illustrating an example process 200 for performing object localization, in accordance with some aspects of the present disclosure. As described below, a particular implementation can omit some or all illustrated features/steps, may be implemented in some examples in a different order or in parallel, and may not require some illustrated features to implement all examples. In some examples, an apparatus (e.g., devices 106 or 202, processor 112 with memory 120, etc. in connection with FIG. 1) can be used to perform all or part of example process 200. However, it should be appreciated that other suitable processing hardware for carrying out the operations or features described below may perform process 200.

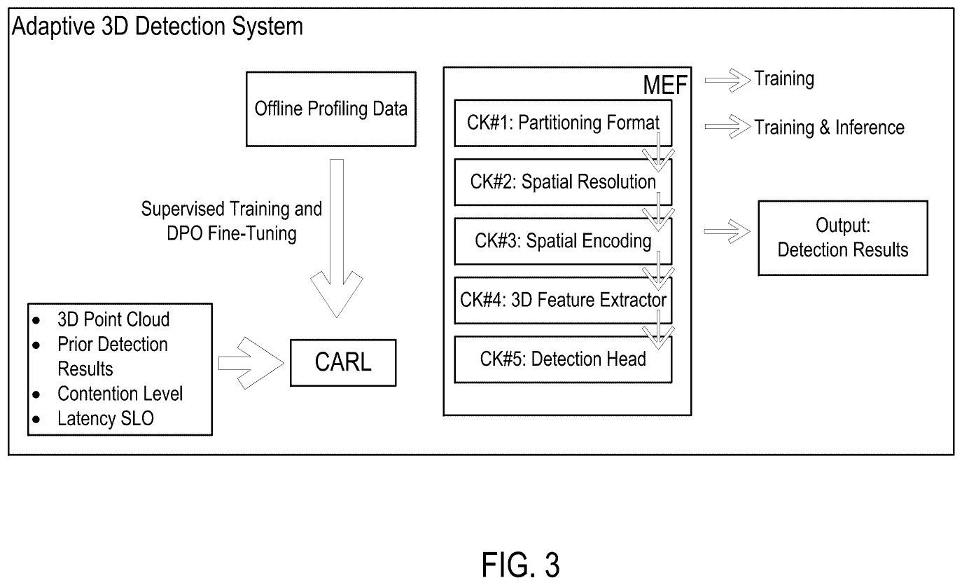

The adaptive 3D system was designed to dynamically adapt to resource contention and input content while meeting strict latency requirements. At its core, the adaptive 3D system features an MEF comprising diverse execution branches managed by the runtime CARL controller. Each branch leverages five tunable modules (“knobs”) across 3D detection components. As described in more detail below with respect to process 200, these interdependent knobs or modules allow the adaptive 3D system to flexibly balance latency and accuracy, extending grid-based 3D detection methods for diverse performance tuning. In some examples, the system buffers and preheats the MEF in memory on embedded devices during an initial phase, enabling sub-1 ms branch switching and ensuring timely responsiveness. With the CARL controller's contention- and content-aware strategy, the adaptive 3D system achieves high accuracy and low latency violation ratio across diverse scenarios. FIG. 3 illustrates how MEF and CARL enable the adaptive 3D system to function as the first adaptive 3D detection system operable on embedded GPUs.

At operation 205, point cloud data is acquired that was obtained from a LiDAR sensor. In some examples, the point cloud data may be acquired by the computing device 106 from the data source 102, with respect to FIG. 1.

At operation 210, a partitioning module is used to determine a partitioning format for the point cloud data. In some examples, the partitioning module (e.g., the point cloud encoding format) may define how raw point cloud data is encoded, either into voxels (i.e., 3D cuboids that capture volumetric information) or pillars (i.e., vertical columns with no vertical resolution). For example, voxel partitioning may capture finer spatial details and enhance accuracy, but increase computational requirements. Moreover, in some examples, pillar partitioning may be more efficient, but loses some height information, making it suitable for less complex scenes. Subsequently, at operation 215, the point cloud data is partitioned in the determined partitioning format.

At operation 220, a spatial resolution module adjusts a size of the partitioned point cloud data. In some examples, the spatial resolution module may adjust voxel or pillar sizes to control the granularity of spatial information, balancing a trade-off between speed and detail when executed on a computing device (e.g., computing device 106). For example, larger partitions may reduce detail and computational load, while smaller partitions may capture more detail at the cost of higher latency.

At operation 225, the spatial resolution module encodes the partitioned point cloud data into voxels. In some examples, the spatial resolution module (or spatial encoding module) may determine how point clouds are voxelized. For example, HV partitioning may use fixed grids, limiting points per grid and total number of grids, and improving stability. Moreover, DV partitioning may adapt to data density by eliminating the two limitations, to provide more accurate but may sacrifice some stability.

In some examples, the point cloud data obtained by the LiDAR sensor may be unordered, irregular, and sparse point clouds for spatial mapping. Comparative grid-based methods structure this data through voxelization, balancing efficiency, and computational cost. Comparative techniques that use Hard Voxelization (HV) restrict grid cells and points per cell, causing detail loss in dense areas. In other comparative examples, Dynamic Voxelization (DV) removes these caps, allowing unlimited points per cell, but still uses fixed grid sizes. This results in inefficiencies: dense regions may miss fine details, while sparse regions waste computation on empty grids. Efficient sensor data processing on embedded GPUs, like LiDAR and cameras, relies on lightweight DNNs. These comparative models lack adaptability to dynamic latency SLOs and input variability, limiting their real-world utility.

At operation 230, a feature extraction module selects a neural network model. In some examples, the feature extraction module (or feature extractor) may choose a neural network type for high dimension 3D feature extraction. For example, transformers work with both voxel and pillar data for high accuracy, but are computationally intensive. Moreover, sparse CNNs may be effective for voxel-based data, while 2D CNNs may be effective for suit pillar-based formats, though they may lose some 3D detail.

At operation 235, the partitioned point cloud data is input into the selected neural network model. In some examples, a detection head module may define the method for object localization and recognition. For example, anchor-based methods may use predefined anchors for efficiency, but can struggle with diverse object orientations. Moreover, center-based methods may be more include capabilities for handling rotated or hybrid objects (e.g., vehicles at intersections), though may be more computationally demanding.

At operation 240, the selected neural network model outputs object localization results for the point cloud data. In some examples, the results may identify one or more objects (e.g., cars, pedestrians, cyclists, etc.) and specify details for the object, such as a position, a size, an orientation, or the like within an environment or 3-dimensional space in which the data was obtained from. Moreover, the results may be output via a display (e.g., display 114).

By incorporating these five knobs or modules, the MEF in the adaptive 3D system offers a highly adaptive and configurable framework, ensuring strong performance for 3D object detection with tight latency budget and under resource contention.

The partitioning format, spatial resolution, and 3D feature extractor knobs are interdependent, impacting both computational efficiency and detection accuracy in the adaptive 3D system. Choosing a voxel-based partitioning format for point clouds requires compatible voxel sizes and a 3D feature extractor capable of processing voxels. For instance, a sparse 3D CNN, which efficiently handles voxelized data, may implement a simpler 2D backbone to balance the computational load due to the increased complexity of voxel encoding in comparative examples. This constraint helps the system maintain target latency and processing speed. Modifying voxel or pillar sizes changes the model's input dimensions, often requiring retraining of specific feature extraction layers. 3D Encoders with mini-PointNet-based feature extractors rely on fixed input dimensions in fully connected layers, so adjusting resolution may require from separate models to ensure accuracy and stability. The choice between HV and DV impacts the stability of data processing speed in both the spatial encoding step and subsequent modules, including the backbone and detection head. HV can ensure stable latency by using a fixed number of grid cells and points per grid. This predictability comes at the cost of detail loss in dense regions and computational overhead from processing empty areas. In contrast, DV removes fixed caps, allowing unlimited points per grid cell and dynamically adjusting grid allocation based on input data density. This approach reduces inefficiencies in sparse areas and captures more detail in dense regions. However, DV's reliance on fixed grid sizes and dynamic point aggregation introduces variability in latency, as processing times fluctuate with changes in input density. In summary, HV-based models ensure stable latency but lose accuracy due to fixed grid limits, while DV-based models improve accuracy in dense regions but sacrifice latency predictability. These dependencies indicate that tuning one control knob can necessitate changes in others, making it impractical to adjust these parameters within a single model, unlike in 2D systems. In view of these factors, comparative examples can provide poor results. The adaptive 3D system overcomes this by employing cross-model branching, each targeted for specific control knob configurations, allowing for a broad adaptability range to meet diverse operational requirements.

One of the controller's objectives is to dynamically select the preferred branch at each timestamp that meets latency SLOs and maximizes accuracy given current input and hardware contention. The selection operation can be formulated as: bₒₚₜ=argma [symbol] acc (b, X, C) s.t.l(b, X, C)+l_{c}+lₒ≤lₛ, (1) where [symbol] denotes all branches, X is the input point cloud, C is the contention level, acc (b, X, C) and l (b, X, C) are the accuracy and latency of branch b, l_{c} is the controller cost, lₒ the switching overhead, and lₛ the latency SLO. A direct solution to this problem is impractical during runtime due to the contention- and content dependent latency and unknown accuracy. Therefore, the techniques set forth herein employ RL techniques to predict the preferred branch. This involves two phases: offline training and online prediction. In the offline phase, each branch undergoes profiling on embedded GPUs using an unseen dataset, allowing the controller to learn branch-specific latency and accuracy. During the online phase, the controller selects the branch that meets latency SLO and maximizes the accuracy.

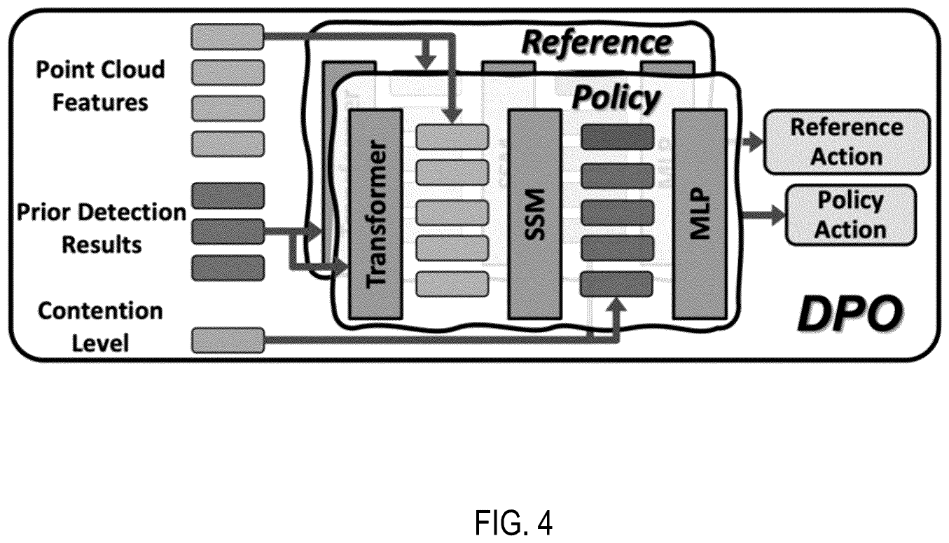

The CARL controller dynamically schedules tasks by considering contention levels and frame specific input content. It employs supervised training for initial learning, followed by DPO fine-tuning with preference labels provided by the Approximate Oracle controller using Beam Search. DPO refines branch selection through preference comparisons instead of absolute scores, ensuring efficiency. The CARL controller undergoes an initial supervised training phase to establish a baseline scheduling policy. It is then fine-tuned using DPO, which leverages branch preference labels generated by the AOB. AOB classifies branch selections as “good” or “bad,” providing training pairs for DPO. By making decisions based on preference comparisons, CARL aligns closely with Oracle performance for dynamic and efficient scheduling. The controller comprises a policy model, which is updated during training, and a reference model, which remains frozen and serves as a stable baseline for calculating the DPO loss, as shown in FIG. 4. Both models share the same architecture for alignment. The model processes raw point clouds using GD-MAE, an efficient framework for 3D feature extraction leveraging sparse representations and masked autoencoding. The extracted features are combined with tokens generated from transformer layers, which encode previous detection results into embeddings. These embeddings provide historical context for informed decision making. The combined features are passed to a State-Space Model (SSM), enabling the controller to model temporal dependencies across consecutive frames. The SSM output is augmented with a positional embedding representing the target latency lₛ, which encodes the system's latency objective into the feature space. Finally, the concatenated features pass through a multi-layer perceptron (MLP) to generate the action distribution, enabling effective branch selection aligned with latency objectives.

### Examples and Experimental Findings

To highlight the need for adaptive 3D systems, emulated structural and latency distribution differences were compared between 2D and 3D detectors. While 2D models process dense, structured images, 3D detectors handle unordered, sparse point clouds, requiring a 3D encoder for spatial feature extraction, which introduces unique latency and computational demands. Several 2Dmodels were benchmarked: Faster RCNN, Sparse RCNN, Dynamic RCNN, SSD, YOLOF, TOOD, and 3D models: SECOND, PointPillars, CenterPoint with CP-Voxel and CP-Pillar variants.

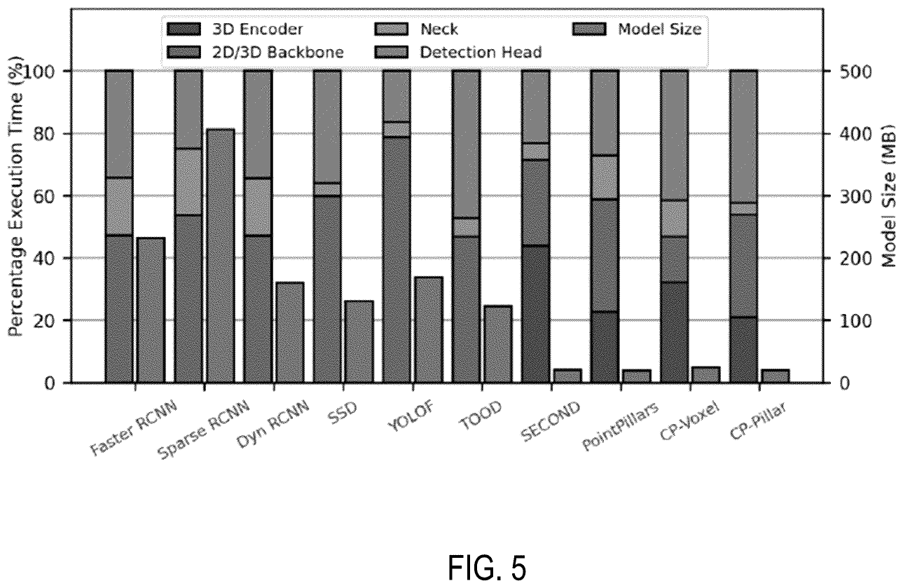

As shown in FIG. 5, latency distributions differ significantly between 2D and 3D models. In 2D, the Backbone dominates latency (47%-78%), followed by the Neck (4%-21%) and Detection Head (16%-47%). For 3D models, the 3D Encoder accounts for 21%-44% of latency, surpassing the Backbone (15%-36%) in absolute computational demand. This highlights the inefficiency of 2D techniques when applied to 3D systems, as 3D models require specialized encoders to process point clouds into structured spatial features. A counter-intuitive observation is that 3D models are significantly more memory-efficient than 2D models. 2D models on COCO average 203.32 MB, whereas 3D models on KITTI average 20.53 MB-nearly one-tenth the size, despite KITTI frames containing 45% of COCO's data volume. This compactness reflects the efficiency of 3D models in leveraging sparse point clouds and voxelization to capture essential spatial information with fewer parameters. Unlike 2D models, which process dense color, texture, and background information, 3D models focus on spatial structure, efficiently encoding occupied regions and surface geometry, thereby reducing memory requirements.

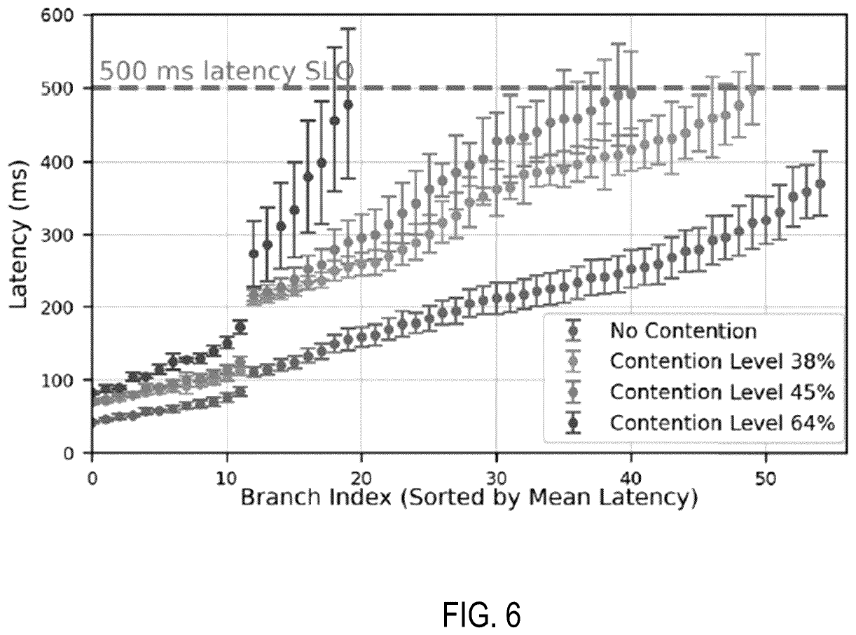

Maintaining low latency violations is used in autonomous systems to ensure timely responses across different scenarios. Significant latency variability in 3D models highlights the need for a contention- and content-aware controller. The latency of all branches was measured in the MEF on an embedded GPU under different contention levels. Higher calibration levels indicate greater resource contention. For each branch, the mean latency, standard deviation, and coefficient of variation (i.e., stddev/mean) was calculated to capture stability, with lower values indicating greater consistency. Results are reported for branches with mean latencies under 500 ms. As shown in FIG. 6, latency variability increases significantly with higher contention levels. The coefficient of variation ranges from 2.62% to 11.91% under no contention, 2.83% to 13.34% under contention level 0.38, 1.94% to 14.13% under contention level 0.45, and 2.13% to 21.38% under contention level 0.64, with heavier models exhibiting higher variance. Two types of latency variance are observed. Within-model variance may refer to variability caused by differences in input point cloud density. Dense or cluttered point clouds require more processing, increasing latency compared to sparser inputs, worsening as contention increases. Between-branch variance may refer to differences that arise due to architectural variations across branches. Operations like grouping, sampling, voxel encoding, and sparse/dense convolution introduce varying computational demands, causing model latency variability. 3D models exhibit significant latency variability under resource contention and dynamic inputs. A contention-aware controller can adapt execution paths, reducing latency violations, and ensuring reliable performance.

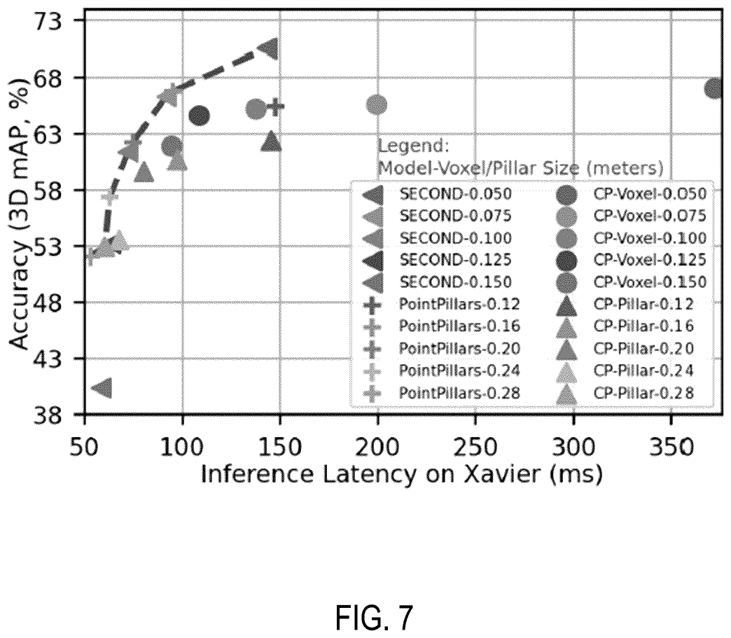

In autonomous systems, latency and accuracy requirements vary based on environmental conditions, system speed, and operational demands. The systems and methods described herein are designed to adapt to these dynamic scenarios, ensuring consistent performance across conditions. Four 3D models were evaluated: SECOND, PointPillars, CP-Voxel, and CP-Pillar, each tested with five grid sizes on Xavier boards. The observed behaviors, shown in FIG. 7 are as follows: [SECOND]: accuracy 40%-70%, latency 58-143 ms; [PointPillars]: accuracy 52%-65%, latency 53-147 ms; [CP-Voxel]: accuracy 62%-67%, latency 94-371 ms; [CP-Pillar]: accuracy 53%-63%, latency 74-186 ms. The relationship between spatial resolution (grid sizes) and detection accuracy is nuanced, especially for different object sizes and classes. For smaller objects, such as pedestrians, higher spatial resolution (smaller grid sizes) improves accuracy due to better feature representation. For instance, PointPillars model PP-0.12 achieves higher accuracy in pedestrian detection (44.46%) compared to PP-0.16 (40.24%). However, for larger objects like cyclists and cars, higher resolution yields fewer gains, as these objects are more easily detectable at lower resolutions due to better global feature aggregation. For example, PP-0.16 outperforms PP-0.12 in detecting cyclists (65.23% vs. 58.73%) and cars (75.98% vs. 69.53%). No single model consistently occupies the Pareto frontier under all conditions. This emphasizes the importance of an intelligent system that balances accuracy and latency under varying SLOs to ensure robust performance, and this approach is adopted in designing the adaptive 3D system.

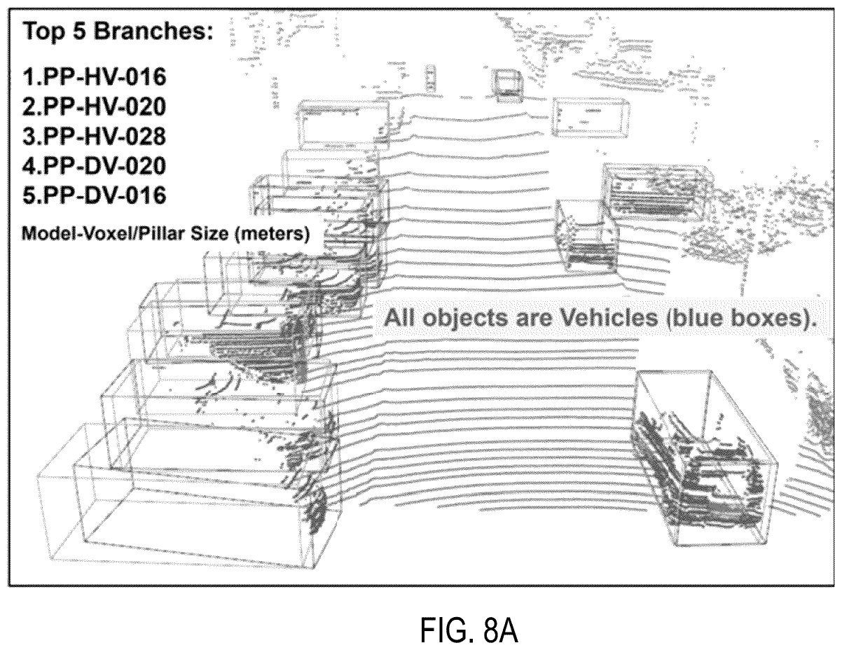

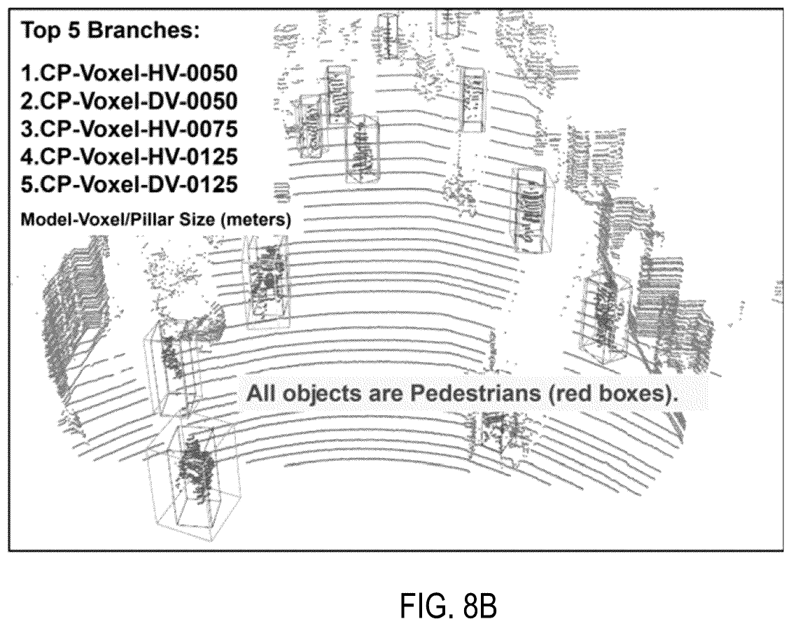

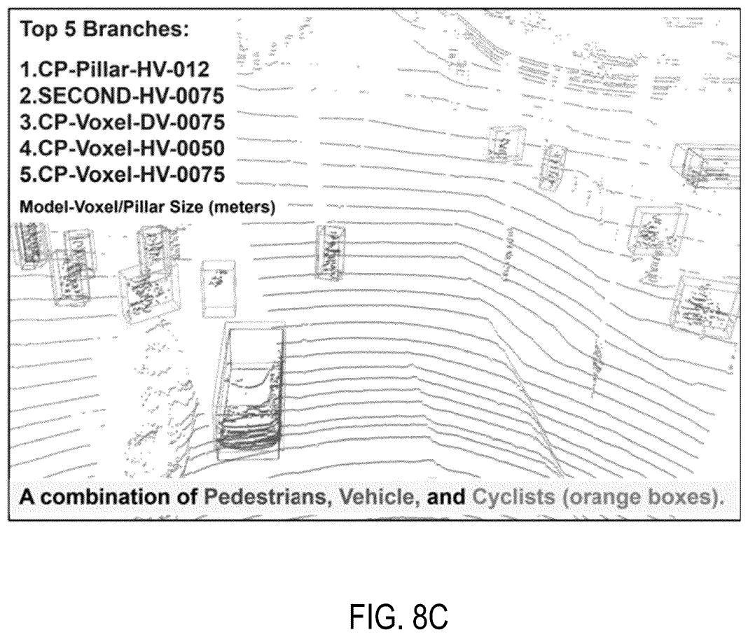

To handle diverse contexts in autonomous systems, a multi-model, content-aware design is employed, where each branch is an independent model. These branches enhance detection accuracy across varied scenarios, highlighting the adaptability of the multi-model approach. Three point clouds with different object compositions are examined: vehicles only (FIG. 8A), pedestrians only (FIG. 8B), and a mix of pedestrians, cyclists, and vehicles (FIG. 8C). Each subfigure lists the top-5 branches by accuracy. FIGS. 8A-8C reveals variability in the preferred branches across contexts. In vehicle-only scenes (FIG. 8A), pillar-based models perform better, as they are suited for simpler environments with large objects and limited vertical detail. In pedestrian-only scenes (FIG. 8B), CP-Voxel models excel due to their ability to detect smaller objects with complex vertical features and diverse rotations. In mixed-object contexts (FIG. 8C), top-performing models include CP-Pillar, SECOND, and CP-Voxel, highlighting the challenge of selecting a fixed model for complex content. Models with anchor-based detection heads work well for axis-aligned objects (FIG. 8A), while center-based detection heads are better suited for non-axis-aligned objects (FIG. 8B).

Supervised learning was used to train the CARL controller, aligning its initial policy with the Oracle's target action b for a given system state S, predicting an action distribution π(⋅|S). The training objective is

$${min}_{π} {ℒ}_{CE} ( π ( \cdot \vert S ) , b ) .$$

While supervised learning targets decisions at each timestamp independently, DPO enhances the CARL controller by considering sequences of actions over time. This approach enables the controller to balance short-term and long-term trade-offs, achieving an improved overall performance. The policy and reference models are initialized from the supervised-trained model. For each state S, positive-negative action pairs (bₚ, bₙ) are generated. The positive action is derived from the AOB controller, while the negative action comes from the reference model. The training objective is formulated as

$${max}_{π} {𝔼}_{( S , {b}_{p} , {b}_{n} ) ∼ 𝒟} {log}_{σ} ( βlog \frac{π ( {b}_{p} \vert S )}{{π}_{ref} ( {b}_{p} \vert S )} - βlog ( \frac{π ( {b}_{n} \vert S )}{{π}_{ref} ( {b}_{n} \vert S )} ) )$$

where π is the policy model, and π_{ref}, the reference model. DPO uses preference comparisons to fine-tune the policy model, aligning it with the AOB controller's decisions and improving sequence-level performance.

The Oracle controller represents the theoretical upper bound for content-aware scheduling by selecting the optimal branch for each frame with full knowledge of ground-truth accuracy. However, implementing such an Oracle is infeasible, as identifying the optimal branch under contention and latency constraints requires an exhaustive search across all branch combinations—a computationally prohibitive task. To approximate, an AOB was employed, which efficiently identifies preferred branch schedules by iteratively refining a limited set of top candidates. AOB serves two main purposes: (1) Benchmarking: Comparing the adaptive 3D system's performance to AOB provides insights into adaptability and areas for targeting under varying conditions; and (2) Training Labels for CARL: AOB generates preferred branch selections per frame, used to fine-tune CARL via DPO, helping CARL approximate Oracle-level performance in dynamic environments.

To address branch execution variability, the DA-LUT controller leverages offline profiling data (mean/variance of latency and accuracy) for efficient branch selection. Assuming Gaussian latency distributions, it calculates confidence levels (e.g., 99%) to minimize latency violations while maintaining SLOs. The controller stores key value pairs in the format<branch, contention, latency mean, latency std, accuracy> and incurs only 1 ms overhead. Lightweight and content-agnostic, the DA-LUT controller excels in low-contention scenarios where latency fluctuations are minimal, outperforming baselines without requiring complex content reasoning.

The adaptive 3D system was trained on NVIDIA A100 GPUs and evaluate it on two NVIDIA Jetson platforms: Orin: 12-core ARM CPU, 2048-core Volta GPU, 64 GB RAM; Xavier: 8-core ARM CPU, 512-core Volta GPU, 32 GB RAM. For stable performance, both platforms were set to max power mode and Dynamic Voltage and Frequency Scaling was disabled. The adaptive 3D system was adapted using Python and PyTorch, based on the OpenPCDet and MMDetection3D codebases.

MEF was constructed by integrating and enhancing a diverse set of 3D detectors, including DSVT, CenterPoint, DV, PointPillars, and SECOND. Rather than naively aggregating these models, the adaptive 3D system systematically calibrates and modifies each component to achieve a balanced trade-off between inference latency and detection accuracy. To ensure performance, voxel based detectors were calibrated in the x and y dimensions (0.1-0.9 m), and the z-dimension (0.1-0.2 m) was adjusted to align with LiDAR sensor configurations. For pillar-based models, the x and y dimensions (0.24-0.9 m) were calibrated while preserving z-heights as per dataset specifications. This distinction arises because voxel-based models require finer z-granularity to capture vertical details, whereas pillar-based models prioritize lateral coverage. Detectors were tuned in MEF and leveraged to address the challenges of 3D point clouds. For large datasets like Waymo and nuScenes, DV was used for efficiency and center-based head for their complex scenes. Each detector employs model-specific setups with standardized preprocessing and augmentations (e.g., rotation, scaling, and flipping along X and Y axes).

The GPU CGs from Chanakya and LiteReconfig were enhanced, adapting them to better simulate real-world workloads. Unlike the original CGs, here the contention is introduced synthetically to mimic the contention level from several 2D models running concurrently with a medium compute-intensity 3D model (DSVT-Pillar with pillar size 0.66). This setup emulates practical embedded systems where 2D models (e.g., processing camera data) and 3D models (e.g., processing LiDAR data) share GPU resources. Due to the diversity of 3D models and their varying contention sensitivities, the evaluation was streamlined by selecting a representative medium-level 3D model. Additionally, prior CG measures GPU utilization offline of standalone processes, ignoring resource sharing during concurrent execution, which cannot be precisely measured on mobile GPUs. To address this, a metric was introduced that quantifies the latency impact of contention on the primary 3D task, defined as Contention Level=(1-L_{wo}/L_{w})*100%, where L_{w}/L_{wo} is the latency with/without contention. Table 1 summarizes the contention levels caused by common 2D models, which range from 28% to 69%, lighter from the mobile CNN models and heavier for the vision transformer model. Given the vast variability in contention levels, four representative levels were selected—[38, 45, 64, 67] %—from the CG for evaluation. To enhance clarity and usability, these levels were categorized as Light, Moderate, Intense, and Peak.

TABLE 1
2D models' contention levels with concurrent 3D workloads.
Transformer-based models (e.g., ViT) exhibit higher contention
than convolutional models (e.g., MobileNet, EfficientNet).

| | Models | | | | | | | | |
|---|---|---|---|---|---|---|---|---|---|
| | MobileNet | | | EfficientNet | | | ResNet50 | ViT | |
| | Variants | | | | | | | | |
| | V4 | V3 | V2 | B0 | B3 | B5 | | Medium | Base |
| Contention | 32 | 36 | 31 | 28 | 30 | 42 | 43 | 62 | 69 |
| Levels (%) | | | | | | | | | |

Latency and accuracy data was collected to train the controller, using distinct datasets to prevent overfitting. Training and profiling datasets are split by time of day, weather, and location for diverse coverage. All branches were profiled on two embedded GPUs under varying contention levels, recording per-sample inference latency. Sample-level accuracy trains the CARL controller to make intelligent decisions, while dataset-level accuracy guides the DA-LUT controller, ensuring efficient decisions for less dynamic scenarios. Branch scheduling was framed as an RL task to train CARL, defining states, actions, and rewards. At each timestep, the state S includes the current point cloud xi, previous detection results di, contention level ci, and latency SLO lsi, concatenated as described herein and shown in FIG. 4. The state is represented as S={(x,d, c, lₛ) i|i=0, 1, . . . , n}. The actions are the branches B={bⱼ|j=0, 1, . . . , m} in the MEF. During DPO training, no explicit reward design is required. For training, sequences of consecutive point clouds X were sampled from the offline profiling data and randomly generate contention levels ci for each sequence. The controller takes the state as input and selects a branch as the action. The corresponding latency/(bCARL) and accuracy acd(bCARL) are then retrieved from the offline profiling data. The controller trained 318,900 episodes using the AdamW optimizer with batch size 16 and a learning rate of 1e-5.

The adaptive 3D system was primarily evaluated on Waymo Open dataset-one of the largest datasets for point cloud based 3D object detection in urban driving scenarios. To demonstrate the generalization of the adaptive 3D system, two other driving datasets were also evaluated: nuScenes and KITTI. Waymo includes 1,150 sequences, with 798/202/150 for training/validation/testing. The training set further split (637/161 for training/profiling) and the official validation set is used for testing. nuScenes contains 1,000 sequences, with 700/150/150 for training/validation/testing. The training set is partitioned into 630/70 for training/profiling, and use the validation set for testing. KITTI comprises 7,481 training and 7,518 testing samples. The training set is split into 3,340/372/3,769 for training/profiling/testing. These benchmarks lack annotations for testing sets, thus reporting results on the validation set is a standard practice. The splits ensure rigorous evaluation with unseen test data. Waymo is the mean Average Precision (mAP) with IoU thresholds of 0.7 (vehicles) and 0.5 (pedestrians/cyclists) for LEVEL2 difficulty. nuScenes: NuScenes Detection Score (NDS) combines mAP with five complementary metrics for comprehensive evaluation. KITTI: mAP is averaged across classes and difficulty levels at 40 recall positions. The baselines include adaptive methods for 3D object detection, leveraging the same set of control knobs. Chanakya was originally designed for 2D workloads, this RL-based content-aware controller is adapted to the 3D setting by engineering its reward structure and integrating it with MEF. The adaptation process requires significant effort due to the increased complexity of 3D point cloud processing and the need for dynamic contention handling. LiteReconfig is a lightweight contention- and content-aware controller for 2D video detection, extended to 3D workloads. The extension involves reconfiguring the contention sensitivity and recalibrating content-awareness for 3D data, which is non-trivial given the higher dimensionality and computation overhead in 3D tasks. DA-LUT is a LUT based controller described herein. Oracle (AOB) is the oracle controller described herein. By using the same set of control knobs for all methods, these baselines comprehensively cover a range of scheduling strategies. DA-LUT is based on LUT, LiteReconfig uses supervised learning, and Chanakya considers RL. In addition, AOB provides an upper bound. For Chanakya, the reward structure was redesigned to handle the increased dimensionality and dynamic nature of 3D point cloud processing. LiteReconfig demanded recalibration to align with the unique contention and content patterns of 3D tasks.

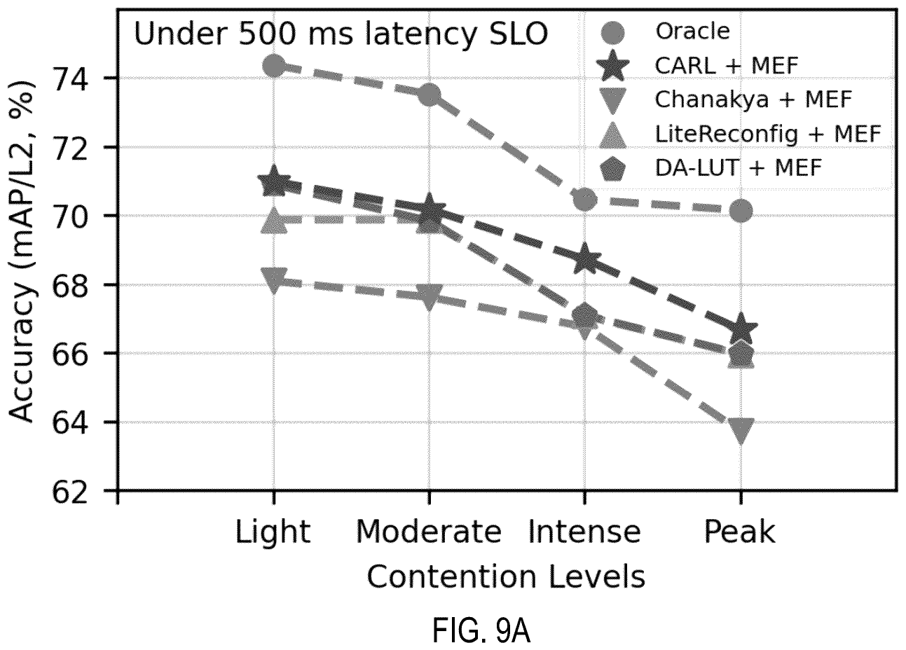

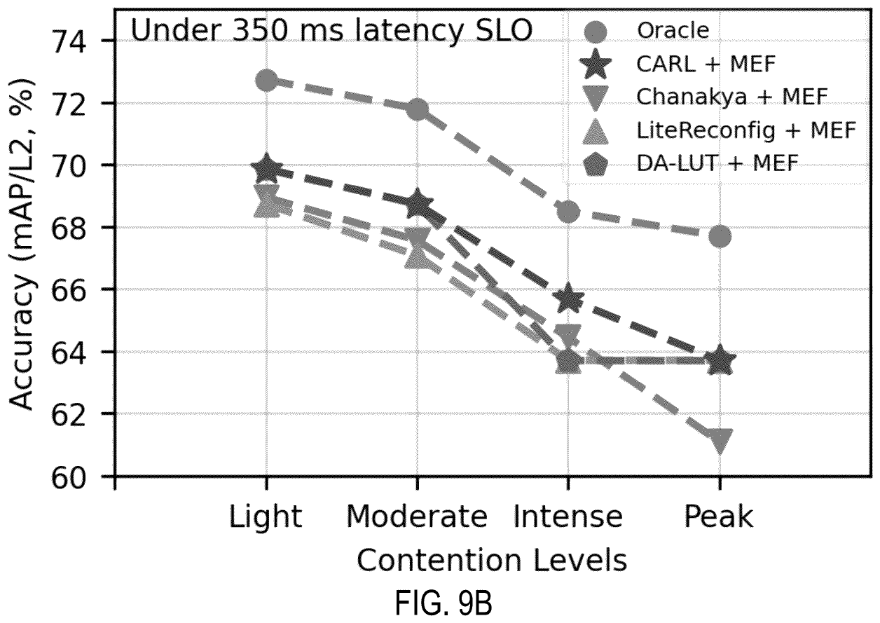

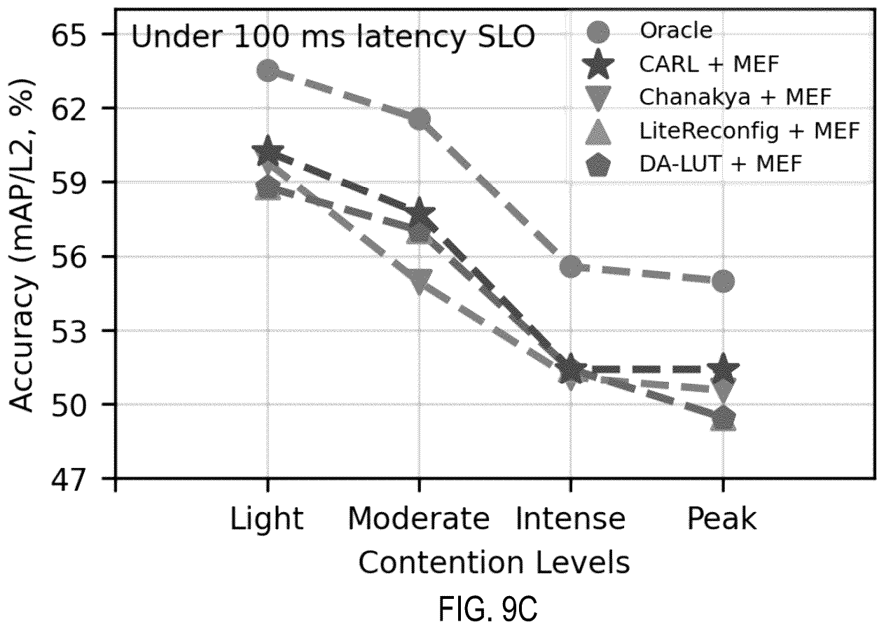

One experiment evaluated the end-to-end performance of the adaptive 3D system under varying contention levels (Light/Moderate/Intense/Peak) and across multiple latency SLOs (500/350/100 ms) on the Orin GPU using the Waymo dataset. These latency SLOs were designed for driving scenarios, where LiDAR point clouds are typically sensed at 10 Hz, while many existing systems process these point clouds at 2 Hz. Further, these latency SLOs are challenging for 3D detection on mobile devices even without contention. The accuracy of the adaptive 3D system, in comparison to the baselines, is summarized in FIGS. 9A-9C. Across all latency SLOs, the adaptive 3D system maintains a latency violation ratio below 10% and outperforms all adaptive baselines by a noticeable margin. For example, at Intense contention, the adaptive 3D system achieves 1.6-3% higher accuracy than the best comparative adaptive method while meeting latency requirements. It is worth noting that while the adaptive 3D system underperforms the oracle AOB, the gap is within 2-5%. Collectively, these results highlight the adaptive 3D system's superior performance in a critical real-world application domain—autonomous driving—despite device contention and tight latency SLOs.

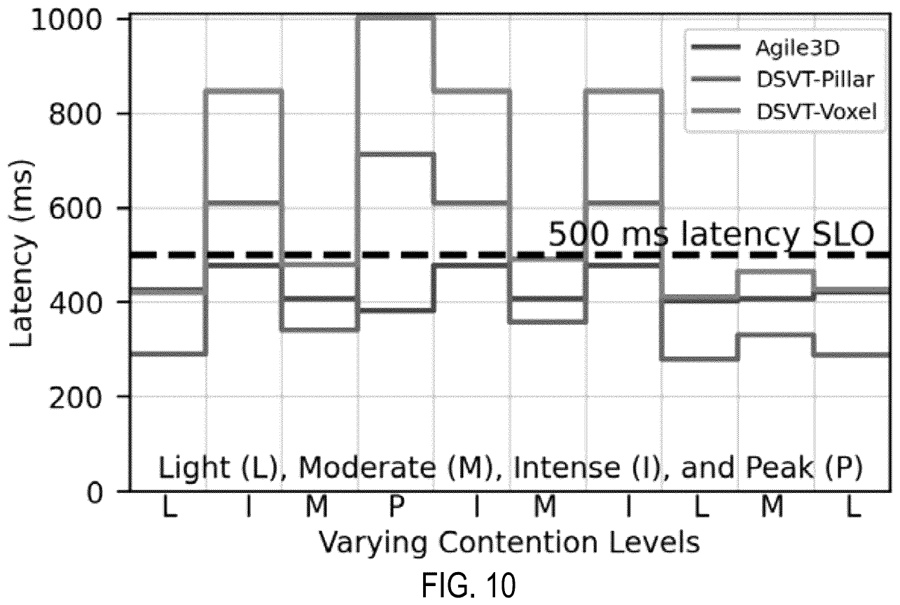

The adaptive 3D system features the ability to adapt to dynamic contention changes on the fly. This was further evaluated by simulating dynamic contention levels using Waymo test set. Specifically, the test set was split into ten segments and each segment was processed under randomly shuffled contention levels, ensuring compliance with the 500 ms latency SLO. Smoothing was performed within each contention level region for ease of interpretation, but observe that even the fluctuations rarely violate the latency SLO. FIG. 10 illustrates that the adaptive 3D system dynamically adjusts to changing contention on the fly, meeting latency requirements while ensuring performance. Static models like DSVT-Pillar and DSVT-Voxel fail to adapt, either violating the latency SLO or under-utilizing the latency budget. These results highlight the adaptive 3D system's strong capability to respond to dynamic conditions changes at runtime.

The performance of the adaptive 3D system was further evaluated without contention. By removing contention, this scenario offers a theoretically interesting case for assessing accuracy-latency trade-offs and comparing the adaptive 3D system to prior 3D object detection models. To this end, seven 3D models were included as a baselines in one example experiment, including DSVT: a Transformer-based model with Voxel and Pillar variants, highlighting SOTA 3D encoders; CenterPoint (CP): Voxel and Pillar variants with center-based heads for robust object localization; Part-A2: a two-stage detector refining proposals for better accuracy and box scoring; PointPillars (PP): an efficient 2D convolution-based 3D detector; SSN: an extension to PP with shape-aware grouping for improved geometric features; PV-RCNN: a combination of voxel and point-based abstraction for enhanced detection accuracy. SECOND: a model using sparse convolutions for efficient voxel-based processing. Due to the dense LiDAR data, experiments on the Waymo and nuScenes datasets are conducted on the Orin platform. In contrast, the KITTI dataset, with its lower data density and smaller detection range, is evaluated on the more resource-constrained Xavier platform.

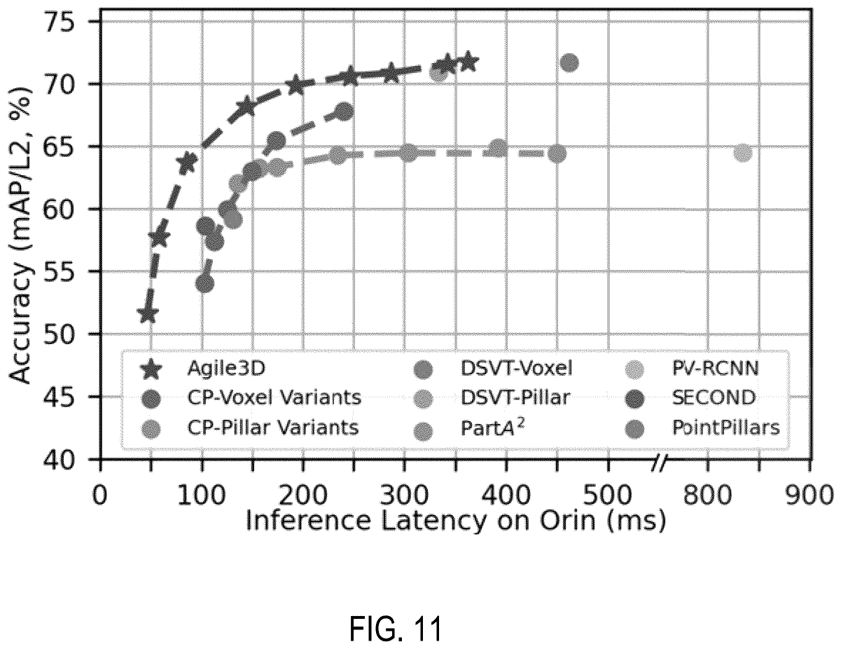

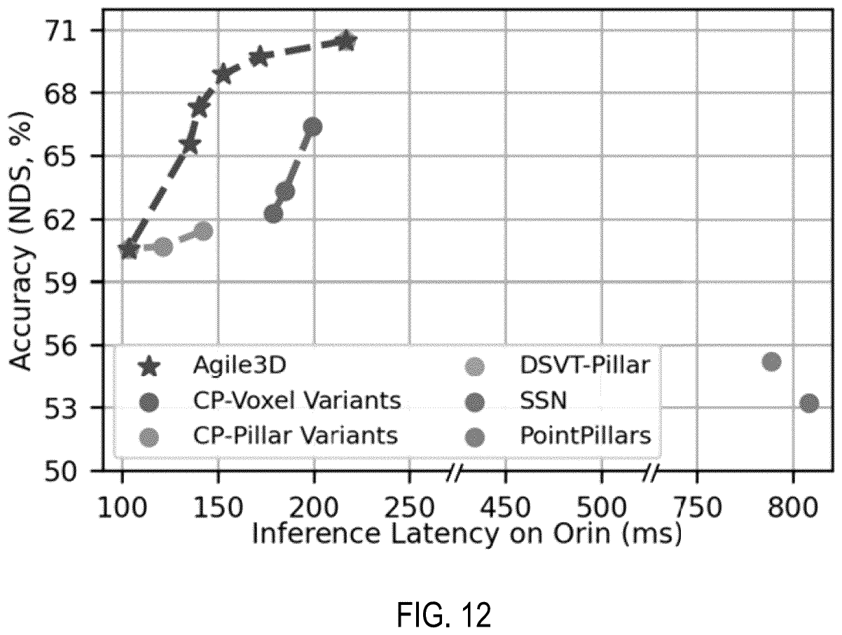

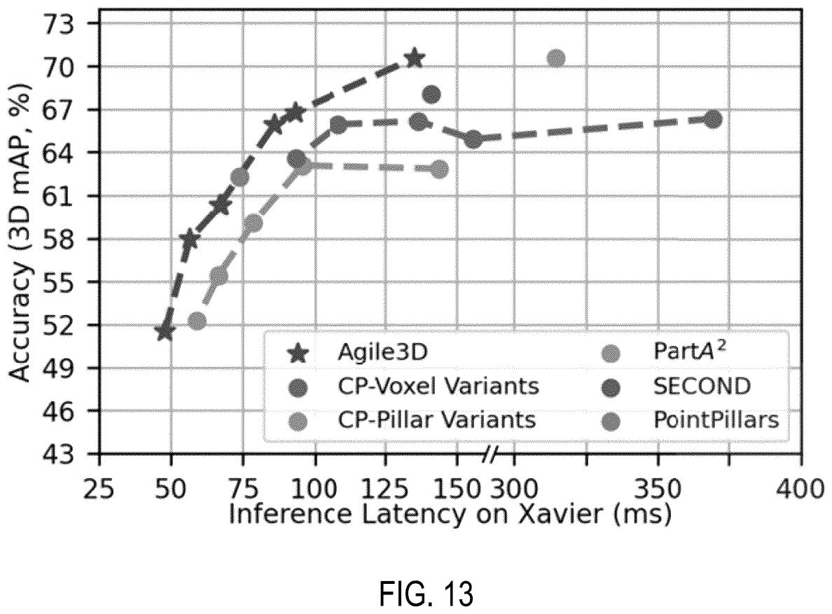

Additionally, DA-LUT was used for nuScenes and KITTI datasets due to their limited annotated data. FIGS. 11-13 illustrate the adaptive 3D system's accuracy-latency tradeoffs versus baseline 3D models under no contention, evaluated across three datasets. On Waymo (Orin, FIG. 11), the adaptive 3D system exceeds baselines, achieving 4-11% higher accuracy under a 200 ms SLO. For nuScenes (Orin, FIG. 12), the adaptive 3D system delivers 7-16% higher accuracy while being 2-4× faster. On KITTI (Xavier, FIG. 13), the adaptive 3D system satisfies a 100 ms SLO, outperforming baselines like PP and CP by 5-7% in accuracy. These trends hold across all datasets, consistently highlighting the adaptive 3D system's superiority in dynamic settings.

One design choice of the adaptive 3D system lies in its training strategy-a combination of supervised pre-training with DPO finetuning. This is in contrast to DA-LUT (statistical modeling), LiteReconfig (supervised training) and Chanakya (Qlearning). The control knobs were fixed and the effects of training strategies were evaluated. Table 2 presents the results on the Waymo dataset and using Orin GPU. The vanilla LUT was additionally included, that ignores the variance of latency, as well as the oracle AOB as the upper bound. While vanilla LUT achieves top accuracy in some cases, it suffers from the highest latency violations (up to 49.95%). Supervised learning (LiteReconfig) and RL (Chanakya) both reduce the violation rate, yet at the cost of decreased accuracy. Instead, the adaptive 3D system's training strategy (supervised learning with DPO fine-tuning) strikes a balance, achieving robust performance with low latency violations across varying contention levels.

TABLE 2
A comparison among training strategies including oracle AOB, vanilla
LUT, statistical modeling (state), supervised learning (SL), reinforcement
learning (RL), and supervised learning following by DPO fine-tuning
(SL + DPO). Accuracy (%), latency (ms), and latency violation
rate (%) under 500 ms latency SLO are reported using Orin GPU.

| Controller | Light | Moderate | Intense | Peak |
|---|---|---|---|---|
| AOB | 74.38/385/0.65 | 73.53/378/0.61 | 70.46/364/0.09 | 70.15/359/1.14 |
| Vanilla LUT | 71.45/506/48.76 | 70.90/501/49.95 | 68.97/505/48.35 | 68.21/472/37.41 |
| Stat | 70.90/430/3.29 | 69.84/381/0.10 | 67.10/340/0.63 | 65.97/328/0.74 |
| SL | 69.87/285/0.00 | 69.87/340/0.00 | 67.08/340/0.63 | 65.96/328/0.74 |
| RL | 68.09/347/0.34 | 67.62/262/0.37 | 66.76/347/0.23 | 63.71/181/0.00 |
| SL + DPO | 70.99/415/5.27 | 70.18/407/0.14 | 68.73/477/1.14 | 66.68/362/5.64 |

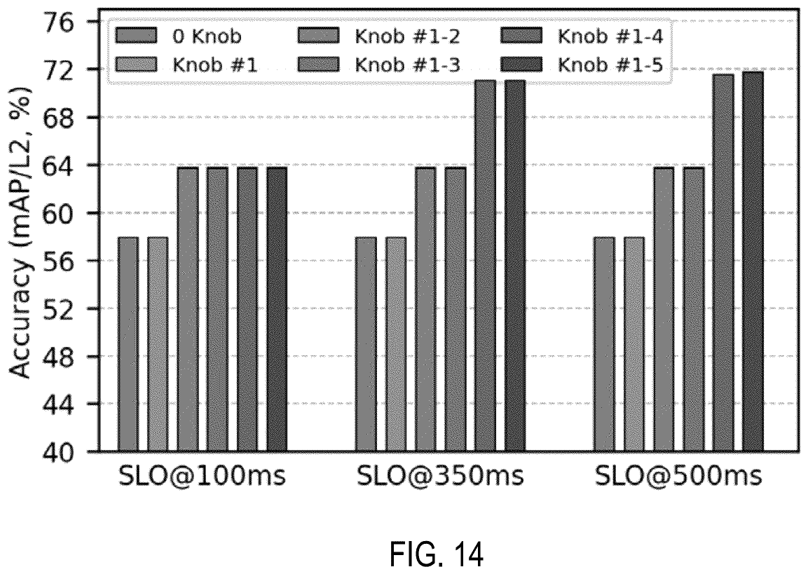

The effects of control knobs on the adaptive 3D system's performance under varying conditions were benchmarked. FIG. 14 illustrates the accuracy under various latency SLOs (100 ms, 350 ms, and 500 ms) with different control knobs, using the Waymo dataset and Orin platform. The results suggest that activating more control knobs enables the adaptive 3D system to meet stricter latency SLOs and improve accuracy. Higher latency SLOs provide additional slack, further boosting performance with the same number of knobs. This experiment was further conducted on the KITTI dataset using both Orin and Xavier, observing a similar trend. However, detailed results are omitted due to space constraints. These findings supports the design of control knobs and demonstrates the role of these knobs in adapting and ensuring performance across datasets and hardware platforms.

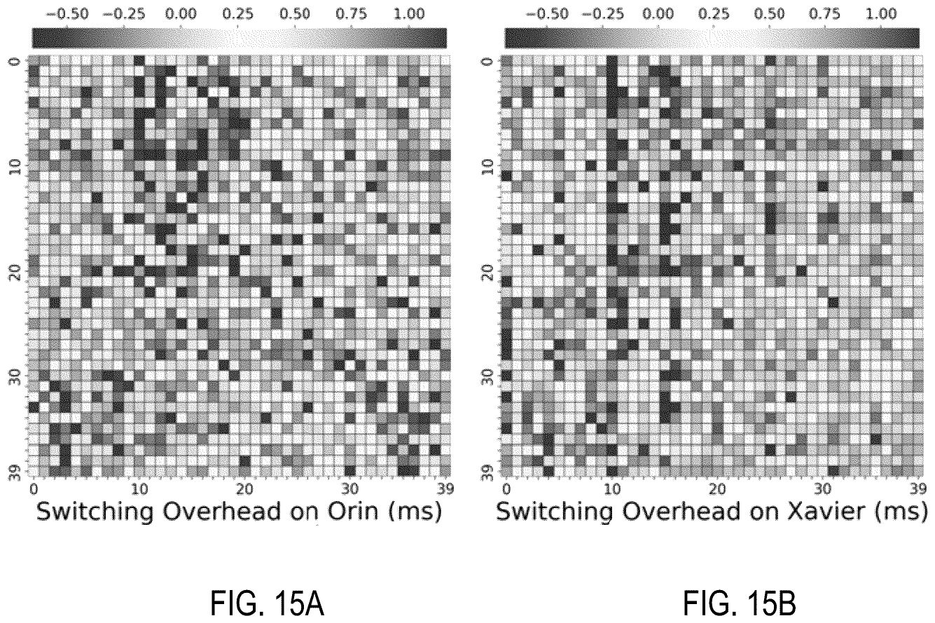

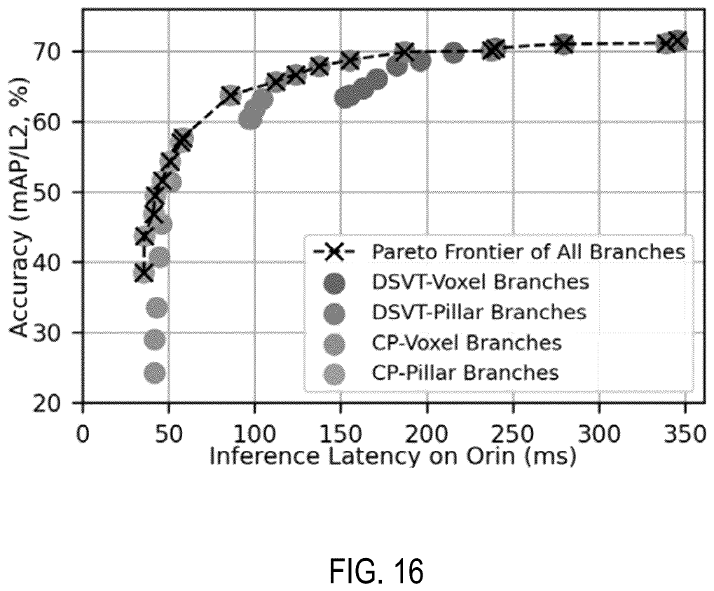

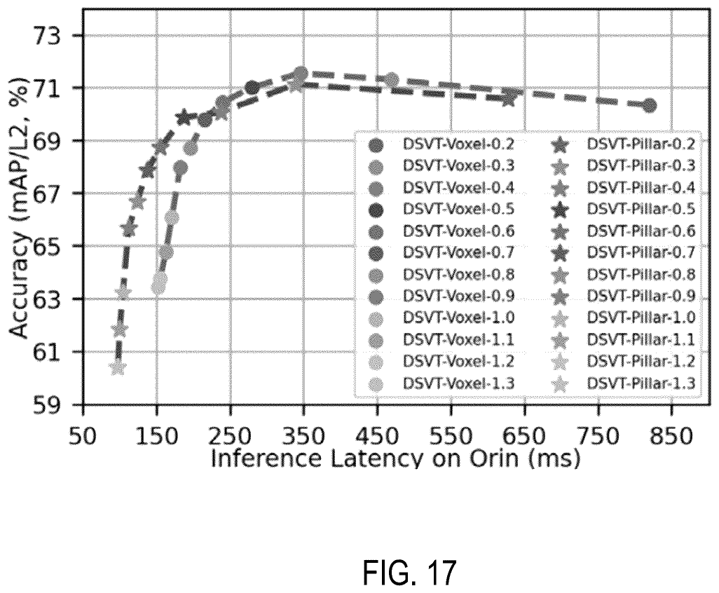

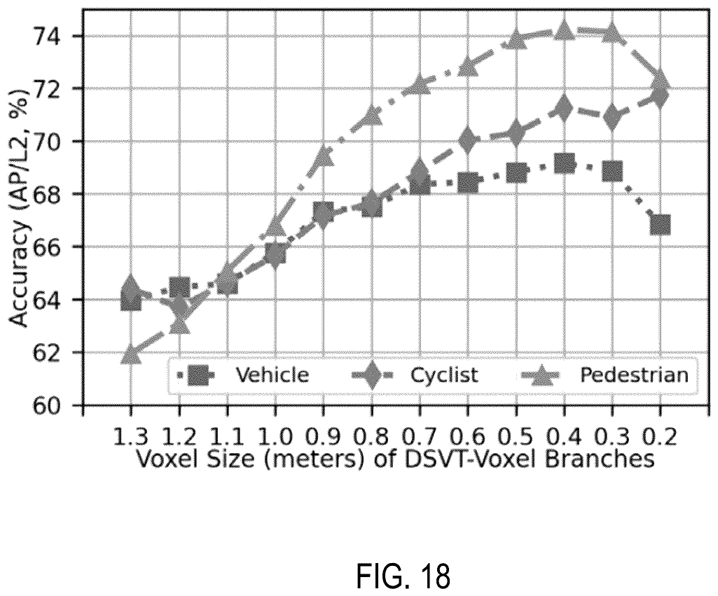

The adaptive 3D system buffers all MEF branches (i.e., individual models) in memory, using <8 GB of RAM, well below the memory capacity of modern mobile devices. This design will introduce a minor branch switching overhead. FIGS. 15A and 15B show this overhead on Orin and Xavier. Pre-buffering limits overhead to under 1 ms, as transitions only require memory-to-GPU operations. In contrast, loading models from disk causes latency spikes exceeding 200 ms. Disk-to-GPU switching costs are 2,394× higher on Xavier (335.16 ms vs. 0.14 ms) and 839× higher on Orin (209.86 ms vs. 0.25 ms). FIG. 16 presents the Pareto frontiers of all branches, reported on the Waymo dataset using Orin GPU. The results illustrate individual branch contributions to the accuracy-latency spectrum. DSVT branches dominate the high-accuracy region, reflecting their precision, while CP branches excel in the low-latency region due to their efficiency. Voxel-based models achieve the highest accuracy, whereas pillar-based models prioritize efficiency. FIGS. 17 and 18 illustrate the impact of voxel/pillar sizes on DSVT performance using the Waymo data on Orin. Smaller voxel sizes theoretically offer higher resolution but do not consistently enhance accuracy. Pedestrians and cyclists are more sensitive to voxel size, with accuracy ranging from 62-74% and 64-72%, respectively, while vehicles show limited variation (64-69%). Overly fine-grained voxelization struggles to capture holistic spatial patterns used for larger objects. Additionally, smaller sizes increase computational workload and latency, producing larger intermediate feature maps that limit efficiency gains despite theoretical benefits.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. An adaptive three-dimensional object detection system, the system comprising:
a memory;
a controller configured to control one or more of: a partitioning module, a spatial resolution module, a spatial encoding module, a feature extraction module, or a detection module stored in the memory; and
a processor electrically coupled to the controller and programmed to:
acquire point cloud data obtained from a LiDAR sensor,
determine, via the partitioning module, a partitioning format for the point cloud data,
partition the point cloud data in the determined partitioning format,
adjust, via the spatial resolution module, a size of the partitioned point cloud data based on a granularity of spatial information,
encode, via the spatial encoding module, the portioned point cloud data into voxels using a voxelization method,
select, via the feature extraction module, a neural network model, wherein the neural network model is compatible with the partitioning format,
input the encoded, partitioned point cloud data to the selected neural network model, and
output, via the selected neural network model, object localization results for the point cloud data.

2. The system of claim 1, wherein the partitioning format is a pillar format and wherein the neural network is a two-dimensional convolutional neural network (CNN).

3. The system of claim 1, wherein the partitioning format is a voxel format and wherein the neural network is a sparse convolutional neural network (CNN).

4. The system of claim 1, wherein the voxelization method is a hard voxelization (HV) method, wherein the partitioned point cloud data is encoded into voxels by:
defining a points per grid value within the point cloud data;
defining a point per cell value within the point cloud data; and
restricting a number of points per voxel based on the values.

5. The system of claim 1, wherein the voxelization method is a dynamic voxelization (DV) method, wherein the partitioned point cloud data is encoded into voxels by:
defining a points per grid value within the point cloud data; and
allowing an unlimited number of points per cell.

6. The system of claim 1, wherein the controller is further configured to:
receive a plurality of service-level objectives (SLOs), wherein the SLOs define a desired accuracy, a desired latency, and one or more resource constraints,
wherein the partitioning module, the spatial resolution module, the spatial encoding module, the feature extraction module, and the detection module operate based on the SLOs.

7. The system of claim 1, wherein the controller is further configured to:
access a plurality of offline profiling data; and
extract an accuracy and a latency of the plurality of offline profiling data,
wherein the partitioning module, the spatial resolution module, the spatial encoding module, the feature extraction module, and the detection module are controlled based on training provided to the controller using the plurality of offline profiling data, the accuracy, and the latency.

8. A method for performing object detection in a three-dimensional environment, the method comprising:
acquiring point cloud data obtained from a LiDAR sensor;
determining, via a partitioning module, a partitioning format for the point cloud data;
partitioning the point cloud data in the determined partitioning format;
adjusting, via a spatial resolution module, a size of the partitioned point cloud data based on a granularity of spatial information;
encoding, via a spatial encoding module, the portioned point cloud data into voxels using a voxelization method;
selecting, via a feature extraction module, a neural network model, wherein the neural network model is compatible with the partitioning format;
inputting the encoded, partitioned point cloud data to the selected neural network model; and
outputting, via the selected neural network model, object localization results for the point cloud data.

9. The method of claim 8, wherein the partitioning format is a pillar format and wherein the neural network is a two-dimensional convolutional neural network (CNN).

10. The method of claim 8, wherein the partitioning format is a voxel format and wherein the neural network is a sparse convolutional neural network (CNN).

11. The method of claim 8, wherein the voxelization method is a hard voxelization (HV) method, wherein the partitioned point cloud data is encoded into voxels by:
defining a points per grid value within the point cloud data;
defining a point per cell value within the point cloud data; and
restricting a number of points per voxel based on the values.

12. The method of claim 8, wherein the voxelization method is a dynamic voxelization (DV) method, wherein the partitioned point cloud data is encoded into voxels by:
defining a points per grid value within the point cloud data; and
allowing an unlimited number of points per cell.

13. The method of claim 8, further comprising:
receiving a plurality of service-level objectives (SLOs), wherein the SLOs define a desired accuracy, a desired latency, and one or more resource constraints,
wherein the partitioning module, the spatial resolution module, the spatial encoding module, the feature extraction module, and a detection module operate based on the SLOs.

14. The method of claim 8, further comprising:
accessing a plurality of offline profiling data; and
extracting an accuracy and a latency of the plurality of offline profiling data,
wherein the partitioning module, the spatial resolution module, the spatial encoding module, the feature extraction module, and a detection module are controlled based on training provided to the controller using the plurality of offline profiling data, the accuracy, and the latency.

15. A non-transitory computer readable medium storing instructions that, when executed, cause a processor to:
acquire point cloud data obtained from a LiDAR sensor;
determine, via a partitioning module, a partitioning format for the point cloud data;
partition the point cloud data in the determined partitioning format;
adjust, via a spatial resolution module, a size of the partitioned point cloud data based on a granularity of spatial information;
encode, via a spatial encoding module, the portioned point cloud data into voxels using a voxelization method;
select, via a feature extraction module, a neural network model, wherein the neural network model is compatible with the partitioning format;
input the encoded, partitioned point cloud data to the selected neural network model; and
output, via the selected neural network model, object localization results for the point cloud data.

16. The non-transitory computer readable medium of claim 15, wherein the partitioning format is a pillar format and wherein the neural network is a two-dimensional convolutional neural network (CNN).

17. The non-transitory computer readable medium of claim 15, wherein the partitioning format is a voxel format and wherein the neural network is a sparse convolutional neural network (CNN).

18. The non-transitory computer readable medium of claim 15, wherein the voxelization method is a dynamic voxelization (DV) method, wherein the portioned point cloud data is encoded into voxels by:
defining a points per grid value within the point cloud data; and
allowing an unlimited number of points per cell.

19. The non-transitory computer readable medium of claim 15, further comprising instructions that, when executed, cause the processor to:
receive a plurality of service-level objectives (SLOs), wherein the SLOs define a desired accuracy, a desired latency, and one or more resource constraints,
wherein the partitioning module, the spatial resolution module, the spatial encoding module, the feature extraction module, and a detection module operate based on the SLOs.

20. The non-transitory computer readable medium of claim 15, further comprising instructions that, when executed, cause the processor to:
access a plurality of offline profiling data; and
extract an accuracy and a latency of the plurality of offline profiling data,
wherein the partitioning module, the spatial resolution module, the spatial encoding module, the feature extraction module, and a detection module are controlled based on training provided to the controller using the plurality of offline profiling data, the accuracy, and the latency.
